(19) United States
(12) Patent Application Publication
(10) Pub. No.: US 2020/0282806 A1
(43) Pub. Date: Sep. 10, 2020

(54) HEATING AND COOLING SYSTEM

(71) Applicant: DENSO International America, Inc., Southfield, MI (US)

(72) Inventor: Rajeev SHARMA, Troy, MI (US)

(21) Appl. No.: 16/697,858

(22) Filed: Nov. 27, 2019

Related U.S. Application Data
(60) Provisional application No. 62/813,407, filed on Mar. 4, 2019.

(51) Int. Cl. B60H 1/00; B60H 1/32; F25B 30/02

(52) U.S. Cl. CPC B60H 1/00907; F25B 30/02; B60H 1/00921; B60H 1/323

(57) ABSTRACT

A heating, ventilation, and air conditioning (HVAC) system having a condenser, an evaporator, a heater, a compressor, and a heat exchanger. The heat exchanger is in an auxiliary case that is spaced apart from the heater and the evaporator. The heat exchanger is in fluid communication with the condenser and the compressor. In a heating mode, refrigerant warmed by the compressor circulates through the heat exchanger to warm airflow moving across the heat exchanger. In a cooling mode, refrigerant cooled by the condenser circulates through the heat exchanger to cool airflow moving across the heat exchanger.

### CROSS-REFERENCE TO RELATED APPLICATION

This application claims the benefit of U.S. Provisional Application No. 62/813,407 filed on Mar. 4, 2019, the entire disclosure of which is incorporated herein by reference.

### FIELD

The present disclosure relates to a heating and cooling system, such as a heating and cooling system for a vehicle.

### BACKGROUND

This section provides background information related to the present disclosure, which is not necessarily prior art.

Typical heating, ventilation, and air conditioning (HVAC) systems for a vehicle include an evaporator for cooling the vehicle's passenger cabin, and a heater core or electric heater for heating the passenger cabin. Thus, current systems require a device for cooling and another separate device for heating. While current HVAC systems are suitable for their intended use, they are subject to improvement. For example, an HVAC system that is more efficient, less costly, and easier to assembly as compared to current systems would be desirable.

### SUMMARY

This section provides a general summary of the disclosure, and is not a comprehensive disclosure of its full scope or all of its features.

The present disclosure includes a heating, ventilation, and air conditioning (HVAC) system having a condenser, an evaporator, a heater, a compressor, and a heat exchanger. The heat exchanger is in an auxiliary case that is spaced apart from the heater and the evaporator. The heat exchanger is in fluid communication with the condenser and the compressor. In a heating mode, refrigerant warmed by the compressor circulates through the heat exchanger to warm airflow moving across the heat exchanger. In a cooling mode, refrigerant cooled by the condenser circulates through the heat exchanger to cool airflow moving across the heat exchanger.

The present disclosure further includes an HVAC system having a front assembly configured to be positioned behind a dashboard of a vehicle. The front assembly has an evaporator, a compressor, a condenser, and a heater. An auxiliary assembly is spaced apart from the front assembly and is configured to be positioned within a passenger cabin of the vehicle. The auxiliary assembly includes a blower and a heat exchanger in fluid communication with the front assembly for circulation of refrigerant between the front assembly and the auxiliary assembly. At least one refrigerant control device is configured to circulate refrigerant warmed by the compressor through the heat exchanger to generate heat in a heating mode. The refrigerant control device is further configured to circulate refrigerant cooled by the condenser through the heat exchanger to generate cooling in a cooling mode.

The present disclosure also includes an HVAC system having a front assembly configured to be positioned behind a dashboard of a vehicle. The front assembly includes an evaporator, a heater, and a blower. An auxiliary assembly is spaced apart from the front assembly and is configured to be positioned within a passenger cabin of the vehicle. The auxiliary assembly includes a blower, a heat exchanger, a condenser, and a compressor. At least one refrigerant control device is configured to circulate refrigerant warmed by the compressor through the heat exchanger to generate heat in a heating mode. The at least one refrigerant control device is also configured to circulate refrigerant cooled by the condenser through the heat exchanger to generate cooling in a cooling mode. Refrigerant lines connect the front assembly to the auxiliary assembly to circulate refrigerant between the front assembly and the auxiliary assembly.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 illustrates an exemplary heating, ventilation, and air conditioning (HVAC) system in accordance with the present disclosure installed in an exemplary vehicle;

FIG. 2. illustrates an exemplary configuration of the HVAC system of the present disclosure;

FIG. 3 illustrates another HVAC system in accordance with the present disclosure;

FIG. 4 illustrates an additional HVAC system in accordance with the present disclosure including a dual zone heat exchanger;

FIG. 5A is a side view of an auxiliary case in accordance with the present disclosure including a blower and a heat exchanger of any of the HVAC systems of the present disclosure;

FIG. 5B is a top view of the case of FIG. 5A;

FIG. 6 is a side view of another auxiliary case in accordance with the present disclosure including a blower and a heat exchanger of any of the HVAC systems of the present disclosure;

FIG. 7 illustrates an exemplary seat in cooperation with an auxiliary case of any one of the HVAC systems of the present disclosure to heat and/or cool the seat;

FIG. 8 illustrates an exemplary seating arrangement, such as of an autonomous vehicle, in cooperation with an auxiliary case of any one of the HVAC systems of the present disclosure to heat and/or cool the seats; and

FIG. 9 illustrates an exemplary pair of seats and a storage box in cooperation an auxiliary case of any one of the HVAC systems of the present disclosure to heat and/or cool the seats and heat and/or cool an interior of the storage box.

Corresponding reference numerals indicate corresponding parts throughout the several views of the drawings.

### DETAILED DESCRIPTION

Example embodiments will now be described more fully with reference to the accompanying drawings.

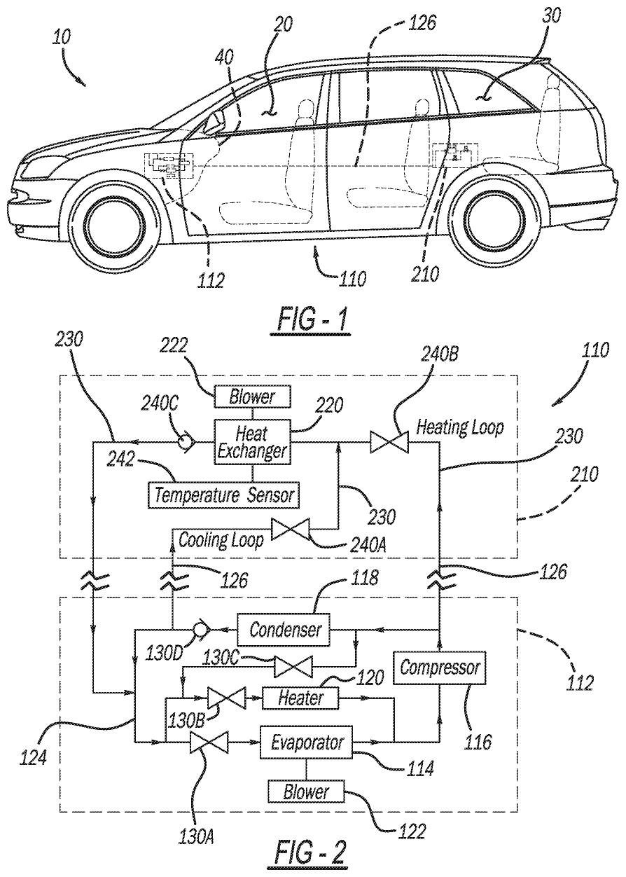

FIG. 1 illustrates an exemplary vehicle 10 including an exemplary heating, ventilation, and air conditioning (HVAC) system 110 in accordance with the present disclosure. The exemplary vehicle 10 includes a front passenger cabin 20 and a rear passenger cabin 30. At a forward most portion of the front passenger cabin 20 is a dashboard 40. Although the exemplary vehicle 10 is illustrated as a passenger vehicle, the HVAC system 110 may be installed in any other suitable type of vehicle as well. For example, in addition to a passenger vehicle, the HVAC system 110 may be installed in any suitable mass transit vehicle, recreational vehicle, utility vehicle, construction vehicle/equipment, military vehicle/equipment, watercraft, aircraft, etc. The HVAC system 110 may be configured for use in any suitable non-vehicular application as well. For example, the HVAC system 110 may be used to heat and/or cool any suitable area of a building or other structure.

The HVAC system 110 generally includes a main (or front) assembly 112 having the various components described herein. The components of the main assembly 112 may be packaged in any suitable manner, such as within any suitable case. As illustrated in FIG. 1, the main assembly 112 is installed behind the dashboard 40 of the exemplary vehicle 10 such that the main assembly 112 is on a side of the dashboard 40 opposite to the front passenger cabin 20.

The HVAC system 110 further includes an auxiliary assembly 210 having the various components described herein. The components of the auxiliary assembly 210 may be arranged in any suitable packaging or case. In the example of FIG. 1, the auxiliary assembly 210 is arranged in the rear passenger cabin 30. The main assembly 112 and the auxiliary assembly 210 are connected by refrigerant lines 126 to allow refrigerant to flow between the main assembly 112 and the auxiliary assembly 210.

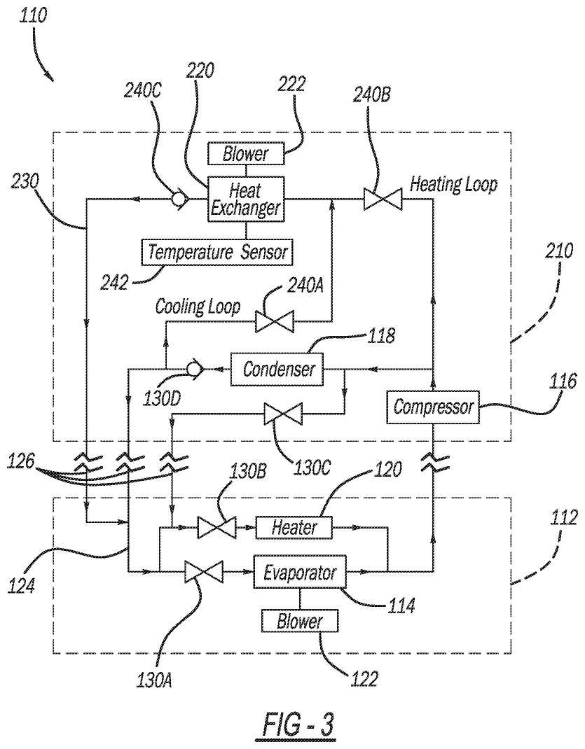

With additional reference to FIG. 2, an exemplary configuration of the main assembly 112 and the auxiliary assembly 210 of the HVAC system 110 will now be described. In the example of FIG. 2, the main (or front) assembly 112 includes an evaporator 114, a compressor 116, and a condenser 118, which are in fluid communication with one another by way of any suitable refrigerant lines 124. The auxiliary assembly 210 may alternatively be configured to include the compressor 116 and the condenser 118, as illustrated in FIG. 3 for example.

The evaporator 114, the compressor 116, and the condenser 118, may also be in fluid communication with any suitable heater 120. A blower 122 is included to circulate airflow cooled by the evaporator 114 or heated by the heater 120. Any suitable refrigerant control devices may be included to control the flow of refrigerant throughout the main assembly 112 and between the main assembly 112 and the auxiliary assembly 210. For example, with respect to the configuration of FIG. 2, valves 130A, 130B, 130C, and 130D may be included to control refrigerant flow. The main assembly 112 is connected to air vents of the front passenger cabin 20 to direct airflow heated or cooled by the main assembly 112 to the front passenger cabin 20.

The auxiliary assembly 210 includes any suitable heat exchanger 220. A blower 222 is arranged in any suitable manner to circular airflow heated or cooled by the heat exchanger 220. A temperature sensor 242 is included to measure the temperature of airflow that has passed across the heat exchanger 220. The temperature sensor 242 may be any suitable temperature sensor, such as any suitable resistance temperature sensor. Refrigerant lines 230 of the auxiliary assembly 210 are arranged to direct refrigerant to and from the heat exchanger 220. The refrigerant lines 230 are in fluid communication with the main assembly 112 by way of refrigerant lines 126. Refrigerant flow to and from the heat exchanger 220 is controlled by any suitable refrigerant control devices, such as by any suitable valves 240A, 240B, and 240C.

The valves 130A, 130B, 130C, 130D, 240A, 240B, 240C, and the compressor 116 may be controlled by any suitable control module of the HVAC system 110 to provide heating or cooling in response to a command from a user, or as prescribed by any suitable heating/cooling algorithm stored within the control module. In this application, “control module” may be replaced with the term “circuit.” “Control module” may refer to, be part of, or include processor hardware (shared, dedicated, or group) that executes code and memory hardware (shared, dedicated, or group) that stores code executed by the processor hardware. The code is configured to provide the features of the control module, and the HVAC system 110 generally, described herein. The term memory hardware is a subset of the term computer-readable medium. The term computer-readable medium, as used herein, does not encompass transitory electrical or electromagnetic signals propagating through a medium (such as on a carrier wave). The term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

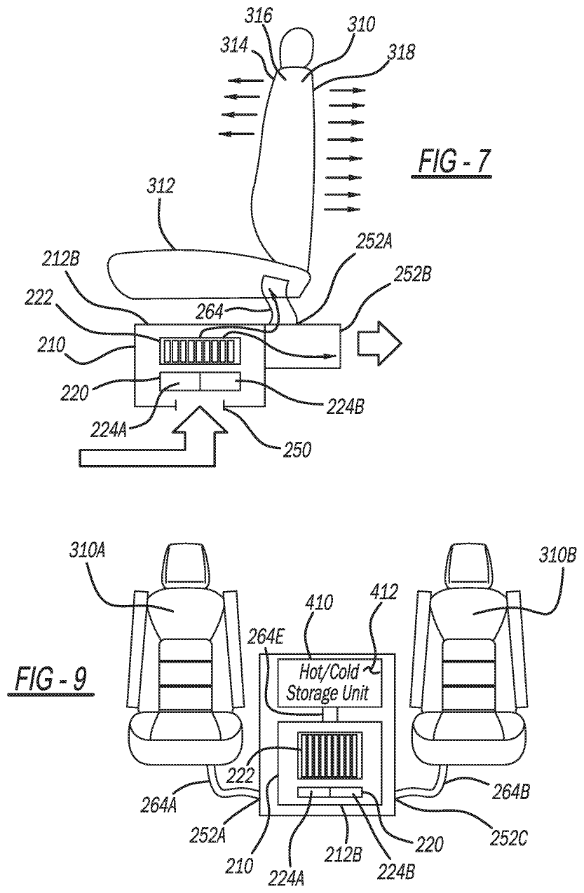

The refrigerant lines 230 delivering refrigerant to the heat exchanger 220 are configured to provide a “heating loop” extending from the compressor 116 to the heat exchanger 220, and a “cooling loop” extending from the condenser 118 to the heat exchanger 220. When ambient air in the rear passenger cabin 30 is lower than a set point set by a user, then a heating mode is activated by the HVAC system 10. In the heating mode, the compressor 116 is activated to compress and pressurize refrigerant flowing therethrough to increase the temperature of the refrigerant to any suitable temperature, such as 60° C. The valve 240B is open, and the valve 240A is closed, to direct the pressurized, high temperature refrigerant to the heat exchanger 220. Airflow generated by the blower 222 is heated as the airflow passes over the heat exchanger 220. The blower 222 blows the heated air out of the auxiliary assembly 210 to heat the surrounding area, such as the rear passenger cabin 30 when the auxiliary assembly 210 is arranged at or near the rear passenger cabin 30 as illustrated in FIG. 1. The temperature to which the airflow generated by the blower 222 is heated by the heat exchanger 220 (as measured by the temperature sensor 242) is a function of the amount of airflow generated by the blower 222 and the degree to which the valve 240B is open. Thus, to produce maximum heating the speed of the blower 222 is set to maximum speed and the valve 240B is opened completely. To generate less than maximum heat, the speed of the blower 222 is set to less than the maximum speed and the valve 240B is not entirely opened. The heated airflow can be used for any other suitable purpose as well. For example and as described further herein, the heated airflow may be directed to one or more seats 310 to heat the seats 310 (FIGS. 7-9), or to a storage unit 410 to heat the contents thereof (FIG. 9).

When ambient air in the rear passenger cabin 30 is greater than a set point set by a user, then a cooling mode is activated by the HVAC system 10. In the cooling mode, the valve 240B is closed and the valve 240A is open to direct refrigerant to the heat exchanger 220 through the “cooling loop.” Specifically, the compressor 116 is deactivated, or activated at a relatively low speed, and the condenser 118 cools refrigerant flowing therethrough because the condenser 118 is configured to radiate heat from the refrigerant. The refrigerant is cooled to any suitable temperature, such as about 2° C. The cooled refrigerant is directed to the heat exchanger 220 through the cooling loop. At the heat exchanger 220, the cooled refrigerant absorbs heat to effectively cool air about the heat exchanger 220. The blower 222 circulates the cooled air within the rear passenger cabin 30 to cool the rear passenger cabin 30. The temperature to which the airflow generated by the blower 222 is cooled by the heat exchanger 220 (as measured by the temperature sensor 242) is a function of the amount of airflow generated by the blower 222 and the degree to which the valve 240A is open. Thus, to produce maximum cooling the speed of the blower 222 is set to maximum speed and the valve 240A is opened completely. To generate less than maximum cooling, the speed of the blower 222 is set to less than the maximum speed and the valve 240A is not entirely opened. The auxiliary assembly 210 may be arranged at any other suitable location to cool the area about the auxiliary assembly 210. For example and as described further herein, the cooled airflow may be directed to one or more seats 310 to cool the seats 310 (FIGS. 7-9), or to a storage unit 410 (FIG. 9) to cool the contents thereof.

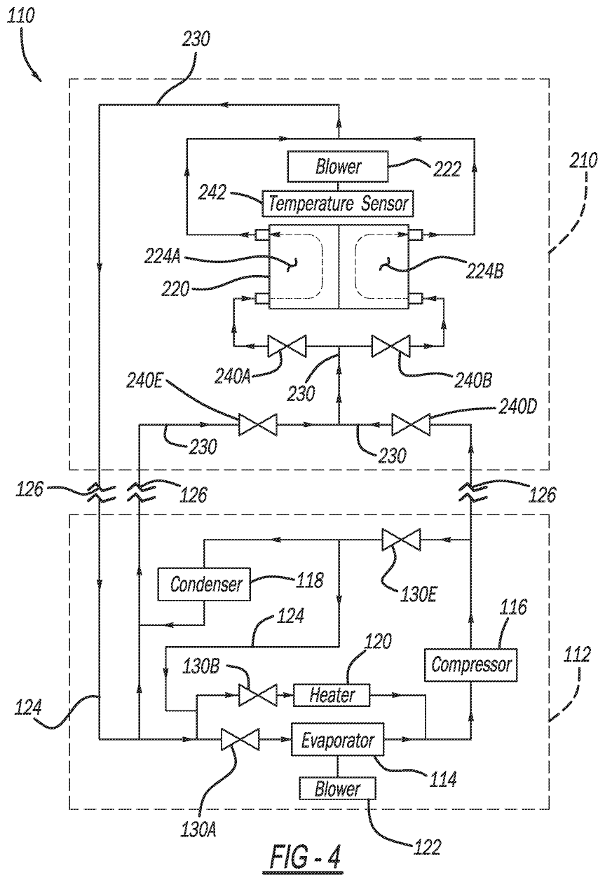

The heat exchanger 220 may be configured as a single zone heat exchanger, or a multizone heat exchanger as illustrated in FIG. 4, for example. FIG. 4 illustrates the heat exchanger 220 as including a first zone 224A of coils and a second zone 224B of coils. Refrigerant flow through the first zone 224A of coils is independent of refrigerant flow through the second zone 224B of coils. Although FIG. 4 illustrates the heat exchanger 220 as including two zones, the heat exchanger 220 may include three or more zones as well. In the dual zone configuration of FIG. 4, refrigerant heated by the compressor 116 or cooled by the condenser 118 is selectively directed to the first zone 224A or the second zone 224B to heat or cool an environment. First valve 240A and second valve 240B control airflow to the first zone 224A and the second zone 224B respectively. Valve 240D controls refrigerant flow from the compressor 116 to the heat exchanger 220, and valve 240E controls refrigerant flow from the condenser 118 to the heat exchanger 220. The valves 240A, 240B, 240D, and 240E may be controlled by any suitable control module of the HVAC system 110 to provide heating or cooling in response to a command from a user, or as prescribed by any suitable heating/cooling algorithm stored within the control module.

In a heating mode, the compressor 116 is activated and refrigerant heated thereby is directed to only the first zone 224A by opening the valve 240D, closing the valve 240E, opening the valve 240A, and closing the valve 240B. In the heating mode, refrigerant heated thereby is directed to only the second zone 224B by opening the valve 240D, closing the valve 240E, opening the second valve 240B, and closing the first valve 240A. Heated refrigerant may be directed to both the first zone 224A and the second zone 224B by opening valves 240A, 240B, and 240D, and closing valve 240E. As explained above, the temperature of airflow generated by the blower 222 depends on the speed of the blower and the degree to which the valve 240D is open.

In a cooling mode, the compressor 116 is not activated and refrigerant cooled by the condenser 118 is directed to only the first zone 224A by closing the valve 240D, opening the valve 240E, opening the valve 240A, and closing the valve 240B. The cooled refrigerant is directed to only the second zone 224B by closing the first valve 240A and opening the second valve 240B. The cooled refrigerant may be directed to both the first zone 224A and the second zone 224B by opening both the first valve 240A and the second valve 240B. Thus, the single heat exchanger 220 can cool airflow passing over the first zone 224A and heat airflow passing over the second zone 224B, or vice versa. Airflow passing over the first zone 224A may be directed to a first location to provide heating or cooling at the first location, and airflow passing over the second zone 224B may be directed to a second location to provide heating or cooling at the second location. As explained above, the temperature of airflow generated by the blower 222 depends on the speed of the blower and the degree to which the valve 240E is open.

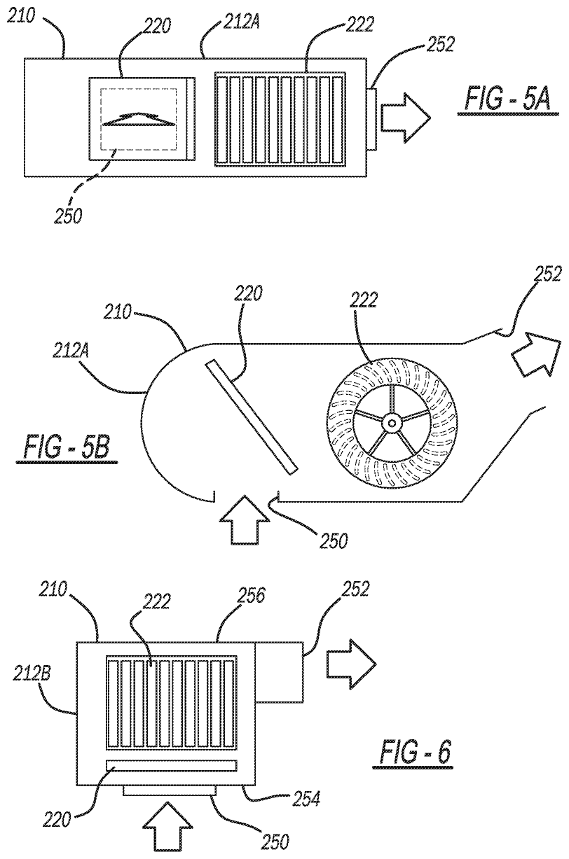

With reference to FIG. 5A and FIG. 5B, the auxiliary assembly 210 may include a case 212A housing at least the heat exchanger 220 and the blower 222. The case 212A may include the compressor 116 and the condenser 118 as well, such as when the HVAC system 110 is configured as illustrated in FIG. 3. The case 212A defines an airflow inlet 250 and an airflow outlet 252. The blower 222 draws airflow into the case 212A through the inlet 250. As the airflow passes over the heat exchanger 220, the airflow is heated or cooled by the heat exchanger 220 depending on whether the heat exchanger 220 is in the heating mode or the cooling mode described above. The blower 220 blows the heated or cooled airflow out from within the case 212A through the outlet 252 to any particular area or structure to be cooled or heated.

In the example of FIGS. 5A and 5B, the inlet 250 and the outlet 252 are both at a side surface of the case 212A, which is between a bottom surface and a top surface of the case 212A. FIG. 6 illustrates an alternative exemplary case 212B for the auxiliary assembly 210. The case 212B includes at least the heat exchanger 220 and the blower 222. The case 212B may further include the compressor 116 and the condenser 118 when the HVAC system 110 is configured as illustrated in FIG. 3. With the case 212B, the inlet 250 is at a bottom surface 254 of the case 212B, and the outlet 252 is at a side surface of the case 212B between the bottom surface 254 and a top surface 256. The blower 222 is arranged to vertically overlap the heat exchanger 220. The configuration of the case 212B of FIG. 6 is generally more compact as compared to the configuration of the case 212A of FIGS. 5A and 5B.

FIG. 7 illustrates an alternate configuration of the auxiliary assembly 210 for heating and cooling a seat 310. As illustrated in FIG. 7, the heat exchanger 220 and the blower 222 of the auxiliary assembly 210 are arranged in the case 212B, which is configured to direct airflow heated or cooled by the heat exchanger 220 to the seat 310 to heat or cool the seat 310. The heat exchanger 220 may be a single zone heat exchanger, or a dual zone heat exchanger including the first zone 224A and the second zone 224B, as illustrated.

The case 212B defines the inlet 250 through which airflow is drawn into the case 212B by the blower 222. The airflow is drawn across the heat exchanger 220 in order to be heated or cooled by the heat exchanger 220 as described above. The airflow exits the case 212B through outlets 252A and 252B. The outlet 252A is connected to the seat 310 by way of an airflow conduit 264 to direct heated or cooled airflow to the seat 310 for heating or cooling a base 312 and a front surface 314 of a back support 316. Airflow exits the seat 310 through a rear duct 318 at a rear of the back support 316. Airflow heated or cooled by the heat exchanger 220 also exits the outlet 252B to heat or cool any desired area. For example, the outlet 252B may be arranged at a lower portion of the rear passenger cabin 30 to heat or cool the rear passenger cabin 30 and particularly direct heated or cooled airflow to the feet of passengers seated at the rear passenger cabin 30. When the heat exchanger 220 is configured with the first zone 224A and the second zone 224B, airflow exiting the outlets 252A and 252B can advantageously be heated or cooled to different temperatures.

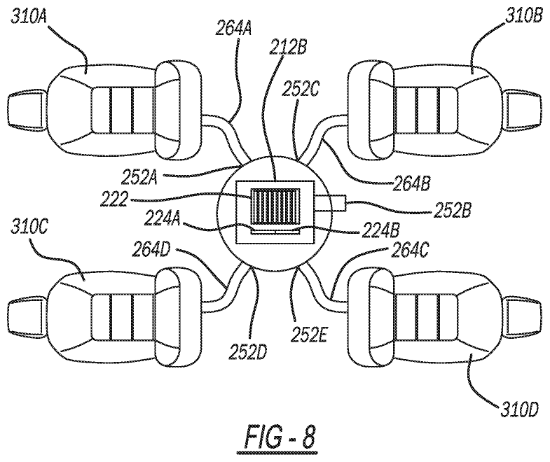

With reference to FIG. 8, the HVAC case 212B includes a plurality of seat outlets 252A, 252C, 252D, and 252E to heat or cool multiple seats, such as four seats 310A, 310B, 310C, and 310D. The seat outlets 252A, 252C, 252D, and 252E may be connected to the seats 310A, 310B, 310C, and 310D in any suitable manner, such as by way of any suitable airflow conduits 264A, 264B, 264C, and 264D respectively. The case 2128 may also include the foot outlet 252B to heat and/or cool the passengers of the seats 310A-310D, and particularly their feet. The four seat arrangement of FIG. 8 may be particularly useful for an autonomous vehicle, or any vehicle with seats configured for socializing.

FIG. 9 illustrates another application for the auxiliary assembly 210, and particularly the case 2128 including the heat exchanger 220 and the blower 222. Specifically, the case 212B is connected to first seat 310A and second seat 3108 by first conduit 264A and second conduit 264B respectively. The first conduit 264A extends from the outlet 252A to the first seat 310A. The second conduit 264B extends from the outlet 252C to the second seat 310B. Although two seats 310A and 310B are illustrated, any suitable number of seats may be heated or cooled by the auxiliary assembly 210, such as one seat as described above with respect to the configuration of FIG. 7, or four seats as described above in the configuration of FIG. 8. The HVAC case 212B may also include the foot outlet 252B to heat or cool the feet of occupants of the seats 310A, 310B. The case 212B further includes a conduit 264E extending between the case 212B and a storage unit 410. The conduit 264E extends from an outlet of the case 2128 to any suitable connection of storage unit 410 to direct airflow heated or cooled by the heat exchanger 220 to the storage unit 410 for heating or cooling an interior 412 of the storage unit 410. The storage unit 410 is configured to store any suitable items to be heated or cooled, such as any suitable food and/or beverage.

The present disclosure thus advantageously provides for an auxiliary assembly 210 including a single heat exchanger 220 configured to generate hot or cold airflow nearly instantly with less parts (e.g., no temperature control doors) as compared to current HVAC systems. The single heat exchanger 220 may be configured to heat or cool an environment about the auxiliary assembly 210, such as the rear passenger cabin 30. The heat exchanger 220 can advantageously be used as both a condenser for heating and an evaporator for cooling because there is no need for the auxiliary assembly 210 to provide dehumidification, such as for a rear window. The auxiliary assembly 210 may also be configured such that an airflow outlet of the auxiliary assembly 210 is connected to one or more seats 310 or storage unit 410 to heat or cool the seats 310 and the storage unit 410. Thus, the auxiliary assembly 210 is able to provide heating or cooling using only the single heat exchanger 220. The heat exchanger 220 is thus effectively able to function as an evaporator for cooling and a condenser for heating. The heat exchanger 220 is particularly effective for use in the auxiliary assembly 210 because the air has already been conditioned by the main assembly 112. The HVAC system 110 provides an improved coefficient of performance, particularly when used in a battery electric vehicle. The HVAC system 110 is able to run the blower 222 at lower speeds, which advantageously saves power, reduces airside pressure drop, and improves fuel economy. The HVAC system 110 is also able to run the compressor 116 and any corresponding water pump at reduced power to further improve fuel economy. The HVAC system 110 is relatively lighter than previous HVAC systems, such as due to elimination of glycol and reduced plumbing requirements. Furthermore, the auxiliary assembly 210 requires less space in the vehicle 10 due to elimination of temperature control doors, the presence of only one heat exchanger, and the elimination of a water loop. One skilled in the art will appreciate that the present disclosure provides numerous additional advantages as well.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A heating, ventilation, and air conditioning (HVAC) system comprising:
a condenser;
an evaporator;
a heater;
a compressor; and
a heat exchanger in an auxiliary case that is spaced apart from the heater and the evaporator, the heat exchanger is in fluid communication with the condenser and the compressor;
wherein in a heating mode refrigerant warmed by the compressor circulates through the heat exchanger to warm airflow moving across the heat exchanger, and in a cooling mode refrigerant cooled by the condenser circulates through the heat exchanger to cool airflow moving across the heat exchanger.

2. The HVAC system of claim 1, further comprising a refrigerant flow control device configured to: permit refrigerant flow from the compressor to the heat exchanger in the heating mode; and restrict refrigerant flow from the compressor to the heat exchanger in the cooling mode.

3. The HVAC system of claim 1, further comprising a refrigerant flow control device configured to permit refrigerant flow from the condenser to the heat exchanger in the cooling mode; and restrict refrigerant flow from the condenser to the heat exchanger in the heating mode.

4. The HVAC system of claim 1, wherein the heat exchanger is a multi-zone heat exchanger having a first zone configured to selectively receive refrigerant cooled by the condenser or heated by the compressor to heat or cool a first area, and having a second zone configured to selectively receive refrigerant cooled by the condenser or heated by the compressor to heat or cool a second area that is different from the first area.

5. The HVAC system of claim 1, further comprising:
a main case configured to be arranged behind a front dashboard of a vehicle, the main case including the condenser, the compressor, the heater, and the evaporator;
a blower included with the auxiliary case configured to circulate airflow heated by, or cooled by, the heat exchanger; and
refrigerant lines connecting the main case to the auxiliary case to circulate refrigerant between the main case and the auxiliary case.

6. The HVAC system of claim 1, further comprising:
a main case configured to be arranged behind a front dashboard of a vehicle, the main case including the heater and the evaporator;
a blower included with the auxiliary case configured to circulate airflow heated by, or cooled by, the heat exchanger, the auxiliary case further including the condenser and the compressor; and
refrigerant lines connecting the main case to the auxiliary case to circulate refrigerant between the main case and the auxiliary case.

7. The HVAC system of claim 1, wherein the auxiliary case is configured to be arranged at a rear passenger cabin of the vehicle such that airflow heated by, or cooled by, the heat exchanger heats or cools the rear passenger cabin of the vehicle.

8. The HVAC system of claim 1, wherein the auxiliary case is configured to be in fluid communication with at least one seat such that airflow heated by, or cooled by, the heat exchanger heats or cools the at least one seat.

9. The HVAC system of claim 1, wherein the auxiliary case is configured to be in fluid communication with a storage unit to heat or cool an interior of the storage unit.

10. The HVAC system of claim 1, wherein the heat exchanger is a single heat exchanger and the auxiliary case is without an additional heat exchanger for heating or cooling.

11. The HVAC system of claim 1, wherein the auxiliary case further includes the condenser and the compressor.

12. A heating, ventilation, and air conditioning (HVAC) system for a vehicle, the HVAC system comprising:
a front assembly configured to be positioned behind a dashboard of the vehicle, the front assembly including an evaporator, a compressor, a condenser, and a heater;
an auxiliary assembly spaced apart from the front assembly and configured to be positioned within a passenger cabin of the vehicle, the auxiliary assembly including a blower and a heat exchanger in fluid communication with the front assembly for circulation of refrigerant between the front assembly and the heat exchanger; and
at least one refrigerant control device configured to circulate refrigerant warmed by the compressor through the heat exchanger to generate heat in a heating mode, and configured to circulate refrigerant cooled by the condenser through the heat exchanger to generate cooling in a cooling mode.

13. The HVAC system of claim 12, wherein the at least one refrigerant control device includes at least one valve.

14. The HVAC system of claim 12, wherein the heat exchanger is a multi-zone heat exchanger having a first zone configured to selectively receive refrigerant cooled by the condenser or heated by the compressor to heat or cool a first area, and having a second zone configured to selectively receive refrigerant cooled by the condenser or heated by the compressor to heat or cool a second area that is different from the first area.

15. The HVAC system of claim 12, wherein the auxiliary assembly is configured to be arranged at a rear of the passenger cabin such that airflow heated by, or cooled by, the heat exchanger heats or cools the rear of the passenger cabin.

16. The HVAC system of claim 12, wherein the auxiliary assembly is configured to be in fluid communication with at least one seat such that airflow heated by, or cooled by, the heat exchanger heats or cools the at least one seat.

17. The HVAC system of claim 12, wherein the auxiliary assembly is configured to be in fluid communication with a storage unit to heat or cool an interior of the storage unit.

18. The HVAC system of claim 12, wherein the heat exchanger is a single heat exchanger and the auxiliary case is without an additional heat exchanger for heating or cooling.

19. A heating, ventilation, and air conditioning (HVAC) system for a vehicle, the HVAC system comprising:
a front assembly configured to be positioned behind a dashboard of the vehicle, the front assembly including an evaporator, a heater, and a blower;
an auxiliary assembly spaced apart from the front assembly and configured to be positioned within a passenger cabin of the vehicle, the auxiliary assembly including a blower, a heat exchanger, a condenser, and a compressor;
at least one refrigerant control device configured to circulate refrigerant warmed by the compressor through the heat exchanger to generate heat in a heating mode, and configured to circulate refrigerant cooled by the condenser through the heat exchanger to generate cooling in a cooling mode; and
refrigerant lines connecting the front assembly to the auxiliary assembly to circulate refrigerant between the front assembly and the auxiliary assembly.

20. The HVAC system of claim 19, wherein the auxiliary assembly is arranged at a rear of the passenger cabin such that airflow heated by, or cooled by, the heat exchanger heats or cools the rear of the passenger cabin.
